(19) United States
(12) Patent Application Publication
(10) Pub. No.: US 2008/0308342 A1
(43) Pub. Date: Dec. 18, 2008

(54) ELECTRIC POWER STEERING APPARATUS

(75) Inventors: Takashi NISHIMORI, Saitama (JP); Hiroyuki TOKUNAGA, Saitama (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd., Tokyo (JP)

(21) Appl. No.: 12/048,813

(22) Filed: Mar. 14, 2008

(30) Foreign Application Priority Data
Mar. 14, 2007 (JP) 2007-065427

(51) Int. Cl. B62D 5/04

(52) U.S. Cl. 180/446

(57) ABSTRACT

An electric power steering apparatus for reducing disturbances caused by loads on a rack shaft is disclosed. The electric power steering apparatus performs compensation so as to obtain a value of zero for the deviation between a target rack travel distance computed by a target rack travel distance computation unit and an actual rack travel distance computed by a rack travel distance computation unit. Bringing the deviation close to zero reduces disturbances originating in the loads on the rack shaft.

### FIELD OF THE INVENTION

The present invention relates to an electric power steering apparatus and, more particularly, to an electric power steering apparatus for reducing the burden of steering on a driver while an automobile is driven.

### BACKGROUND OF THE INVENTION

An electric power steering apparatus comprises a steering force enhancer whose power source is an electric motor, and a control device composed of a microcomputer unit, a motor drive circuit and other components. When a driver applies a steering force to a steering wheel while the vehicle is in motion, the electric power steering apparatus detects the vehicle speed and the steering torque generated in the steering shaft, and the control device uses pulse width modulation (PWM) to drive the motor on the basis of the detection signals. Auxiliary torque that enhances the steering torque is thereby generated, and less steering force is required from the driver. At this time, the value (assist amount) of the generated auxiliary torque is determined according to the steering torque.

An electric power steering apparatus of this type is disclosed in JP 2004-330877 A, an official publication laying open an earlier patent application lodged by the this applicant.

The disclosed electric power steering apparatus is designed so that the motor output does not fluctuate even when fluctuations occur in the output voltage from the power source that supplies electric power to the motor drive circuits in the control device, thus providing a pleasant steering feel to the driver.

In this electric power steering apparatus, a motor controller in the control device includes a target electric current setting unit, an inertia correction unit, and a damper correction unit.

Detection signals from a steering torque detector, a vehicle speed detector, and a motor rotation angle detector (for detecting the motor angular velocity) are inputted to the motor controller.

The basic configuration of the motor controller in this electric power steering apparatus is designed so that the detected information of the steering torque, vehicle speed, and motor angular velocity is used to generate a target electric current value, an inertia correction value, and a damper correction value. A final target electric current control command value is generated based on these values, and the operation of the motor is controlled to obtain the necessary auxiliary torque.

Therefore, in rack-and-pinion mechanisms in which a steering wheel is engaged with a rack shaft provided with turning wheels at both ends, disturbances originating in the load applied to the rack shaft have not been taken into account. In other words, no proposals have been put forward for a control configuration that directly compensates for disturbances caused by the load on the rack shaft.

### SUMMARY OF THE INVENTION

In view of the problems described above, an object of the present invention is to provide an electric power steering apparatus wherein disturbances caused by the load on a rack shaft can be reduced.

According to the present invention, there is provided an electric power steering apparatus for generating an auxiliary torque in accordance with a steering torque, which apparatus comprises: first rack travel distance computation means for computing a target rack travel distance in accordance with a steering angle of a steering wheel, second rack travel distance computation means for computing an actual rack travel distance, deviation computation means for computing a deviation between the target rack travel distance and the actual rack travel distance, and auxiliary torque correction means for correcting a value of the auxiliary torque so that a deviation signal outputted from the deviation computation means is zero.

In the electric power steering apparatus described above, a basic control configuration is used in which a target electric current control command value for generating auxiliary torque to be added to steering torque is created in accordance with the steering torque. This target electric current control command value is corrected based on the deviation between the target rack travel distance and the actual rack travel distance. Specifically, it is possible to directly compensate for disturbances originating in the load on the rack shaft, and the effects of disturbances originating in the load on the rack shaft are reduced.

Preferably, the auxiliary torque correction means is adapted to add the deviation signal outputted from the deviation signal computation means to a target electric current control command value for generating the auxiliary torque.

Desirably, the actual rack travel distance is determined based on a signal obtained by detecting a rotational angle of a motor for generating the auxiliary torque. The rotational angle of the motor is detected by a resolver in the embodiment.

### BRIEF DESCRIPTION OF THE DRAWINGS

A preferred embodiment of the present invention will be described in detail below, by way of example only, with reference to the accompanying drawings, in which:

FIG. 1 is a schematic view illustrating an electric power steering apparatus according to the present invention;

FIG. 2 is a block diagram showing an electrical circuitry of a motor controller of a control apparatus shown in FIG. 1; and

FIG. 3 is a block diagram showing an electrical circuitry of portions of the motor controller shown in FIG. 2, which are a basic control component and a portion for correcting disturbances in a rack load.

### DESCRIPTION OF THE PREFERRED EMBODIMENT

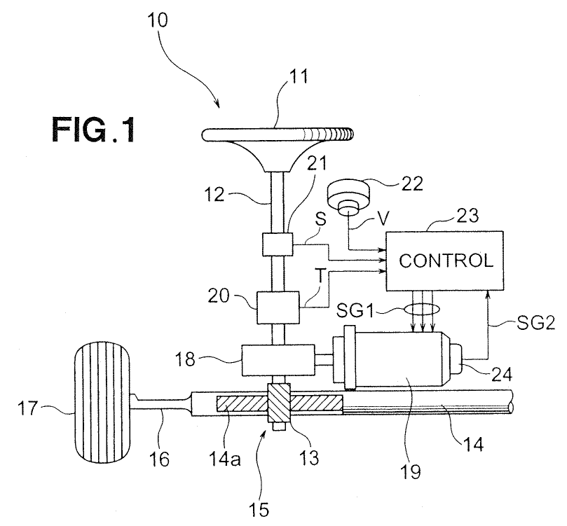

An electric power steering apparatus 10 shown in FIG. 1 applies auxiliary torque to the steering torque applied by a driver to a steering shaft 12 via a steering wheel 11. The steering shaft 12 is connected to the steering wheel 11 at the top end, and a pinion gear 13 is attached to the bottom end. The pinion gear 13 meshes with a rack gear 14a formed in a rack shaft 14. The pinion gear 13 and the rack gear 14a together form a rack-and-pinion mechanism 15. Tie rods 16 are provided at both ends of the rack shaft 14, and turning wheels 17 are attached at the outer ends of these tie rods 16.

A brushless motor 19 that outputs rotational force for assisting the steering torque is connected to the steering shaft 12 via a power transmission mechanism 18. The rotational force of the motor 19 is applied as auxiliary torque to the steering shaft 12 by means of the power transmission mechanism 18.

A steering torque detector 20 is attached to the steering shaft 12. When the driver adds steering torque to the steering shaft 12 by operating the steering wheel 11, the steering torque detector 20 detects the steering torque applied to the steering shaft 12. The steering torque detector 20 is configured from, i.e., a detection device that uses a torsion bar.

A steering angle sensor 21 senses the steering angle in the rotation of the steering shaft 12. A control device 23 includes a microcomputer. The reference numeral 22 denotes a vehicle speed detector.

The control device 23 outputs a motor electric current SG1 for rotatably driving the motor 19, on the basis of a steering torque signal T outputted from the steering torque detector 20, a steering angle signal S outputted from the steering angle sensor 21, and a vehicle speed signal V outputted from the vehicle speed detector 22.

A motor rotational angle detector 24 that includes a resolver is provided to the brushless motor 19. A rotational angle signal SG2 from the motor rotational angle detector 24 is sent as feedback to the control device 23. The rack-and-pinion mechanism 15 is housed within a gear box (not shown).

The electric power steering apparatus 10 has a configuration in which the power transmission mechanism 18, the brushless motor 19, the steering torque detector 20, the steering angle sensor 21, the vehicle speed detector 22, and the control device 23 are added to mechanical devices of a regular steering system.

According to this configuration, when the driver operates the steering wheel 11 to steer the moving automobile, rotational force based on the steering torque applied to the steering shaft 12 is converted by the rack-and-pinion mechanism 15 to linear movement along the axial length of the rack shaft 14, and this linear movement changes the traveling direction of the front wheels 17 via the tie rods 16. At the same time, the steering torque detector 20 attached to the steering shaft 12 detects steering torque corresponding to the driver's steering of the steering wheel 11, converts the steering torque to an electrical steering torque signal T, and outputs this steering torque signal T to the control device 23. The steering angle sensor 21 senses the steering angle or handle angle, and outputs a steering angle signal S to the control device 23. The vehicle speed detector 22 detects the vehicle speed, converts the speed to a vehicle speed signal V, and outputs the vehicle speed signal V to the control device 23.

The control device 23 creates a target electric current control command value on the basis of the steering torque signal T, the steering angle signal S, and the vehicle speed signal V; and generates a motor electric current for driving the brushless motor 19. Driven by the motor electric current, the brushless motor 19 applies auxiliary torque to the steering shaft 12 via the power transmission mechanism 18.

The driving of the brushless motor 19 as described above reduces the steering force applied by the driver to the steering wheel 11.

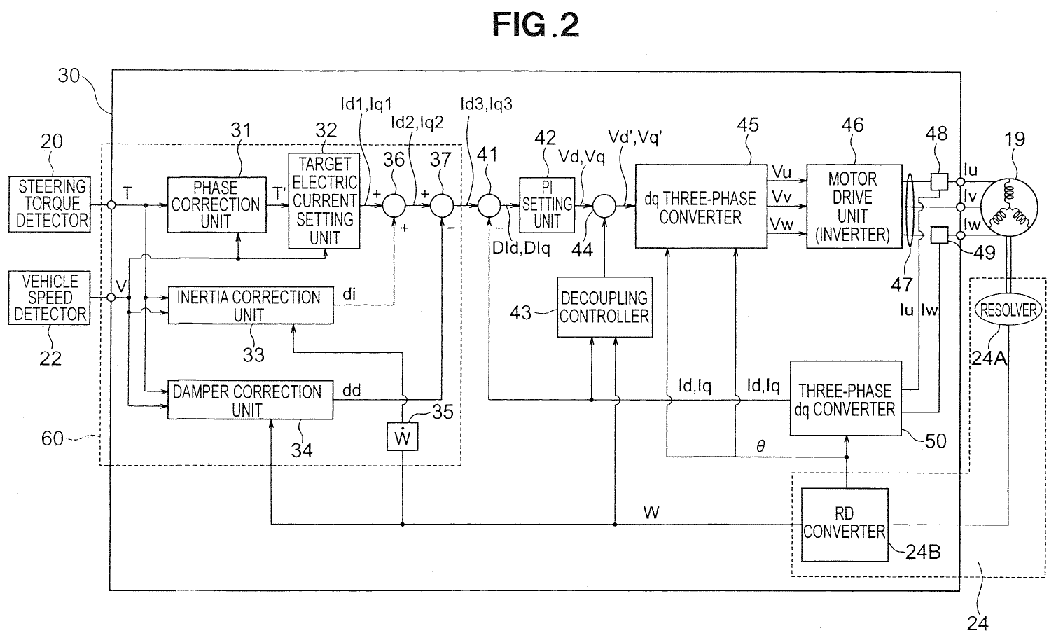

The following is a description, made with reference to FIG. 2, of an example of the configuration of a basic motor controller for controlling the rotational angle of the brushless motor 19. This motor controller 30 is provided within the control device 23.

A resolver 24A for detecting the rotational angle of the brushless motor 19 is attached thereto. The resolver 24A is included in the motor rotational angle detector 24.

The motor controller 30 for controlling the rotational angle of the brushless motor 19 comprises, on the input side, a phase correction unit 31, a target electric current setting unit 32, an inertia correction unit 33, and a damper correction unit 34.

The phase correction unit 31 corrects the phase of the steering torque signal T from the steering torque detector 20 on the basis of the vehicle speed signal V from the vehicle speed detector 22, and outputs a corrected steering torque signal T′ to the target electric current setting unit 32.

The inertia correction unit 33 creates an inertia correction signal di for correcting inertia. The inertia correction unit 33 creates this signal on the basis of the steering torque signal T from the steering torque detector 20, the vehicle speed signal V from the vehicle speed detector 22, and an angle acceleration rate signal from a differentiation processor 35 for differentiating a rotational angular speed signal (motor angle speed signal) W outputted from the motor rotational angle detector 24. The inertia correction signal di is inputted to an addition computation unit 36.

The damper correction unit 34 creates a damper correction signal dd for correcting damper. The damper correction unit 34 creates this signal on the basis of the steering torque signal T from the steering torque detector 20, the vehicle speed signal V from the vehicle speed detector 22, and the rotational angular speed signal W from a resolver/digital (RD) converter 24B of the motor rotational angle detector 24. The damper correction signal dd is inputted to a subtraction computation unit 37.

The target electric current setting unit 32 calculates and outputs two target electric currents (Id1, Iq1) on the basis of the corrected steering torque signal T′ and the vehicle speed signal V. The two target electric currents (Id1, Iq1) correspond to the d axis and q axis, respectively, of a permanent magnet over the rotor of the brushless motor 19, in a rotating coordinate system synchronized with a magnetic flux created by the permanent magnet. The two target electric currents (Id1, Iq1) are referred to respectively as the “d-axis final target electric current” and the “q-axis final target electric current.”

The inertia correction signal di is added to the two target electric currents (Id1, Iq1) by the addition computation unit 36, and inertia-corrected target electric currents (Id2, Iq2) are created. The damper correction signal dd is subtracted from the inertia-corrected target electric currents (Id2, Iq2) by the subtraction computation unit 37, and damper-corrected target electric currents (Id3, Iq3) are created. These damper-corrected target electric currents (Id3, Iq3) are referred to respectively as the “d-axis final target electric current” and the “q-axis final electric current.”

The output side of the motor controller 30 is provided with a deviation computation unit 41, a PI setting unit 42, a decoupling controller 43, a computation unit 74, a dq-3 phase converter 75, a motor drive unit (inverter) 46, three drive electric current paths 47, motor electric current detectors 48, 49, and a three-phase-dq converter 50.

The d- and q-axis detected electric currents (Id, Iq) are subtracted from the d-axis final and q-axis final target electric currents (Id3, Iq3) by the deviation computation unit 41, and the deviations (DId, DIq) are obtained. These deviations (DId, DIq) are inputted to the PI setting unit 42.

The PI setting unit 42 performs a computation based on the deviations (DId, DIq), and sets target voltages (Vd, Vq) so that the detected electric currents (Id, Iq) match the final target electric currents (Id3, Iq3). These target voltages (Vd, Vq) are corrected to d- and q-axis corrected target voltages (Vd′, Vq′) by the decoupling controller 43 and a computation unit 44, and are inputted to a dq-three-phase converter 45.

In FIG. 2, one addition computation unit 36, subtraction computation unit 37, deviation computation unit 41, PI setting unit 42, and computation unit 44 each are depicted for the sake of convenience, but in practice, one of each of these is provided for each of two target electric currents (Id1, Id2).

On the basis of the detected electric currents (Id, Iq) and the rotational angular speed signal W of the rotor, the decoupling controller 43 calculates a decoupling control correction value for the target voltages (Vd, Vq).

The computation unit 44 computes the corrected target voltages (Vd′, Vq′) by subtracting the decoupling control correction value from the target voltages (Vd, Vq). These corrected target voltages (Vd′, Vq′) are inputted to the dq-three-phase converter 45.

The dq-three-phase converter 45 converts the corrected target voltages (Vd′, Vq′) to three target voltages (Vu, Vv, Vw). These three target voltages (Vu, Vv, Vw) are inputted to the motor drive unit (inverter) 46.

The motor drive unit 46 includes a PWM voltage generator (pre-drive circuit) and an inverter circuit. The motor drive unit 46 creates PWM control voltage signals that correspond to the three target voltages (Vu, Vv, Vw) and outputs the signals to the inverter circuit, and the inverter circuit generates three AC drive voltages (Iu, Iv, Iw). These three AC drive voltages (Iu, Iv, Iw) are supplied to the brushless motor 19 via the drive electric current paths 47.

Motor electric current detectors 48, 49 are provided to two of the three drive electric current paths 47. The motor electric current detectors 48, 49 detect the drive electric currents Iu, Iw and output the currents to the three-phase-dq converter 50. The three-phase-dq converter 50 calculates the remaining drive electric current Iv on the basis of these detected drive electric currents Iu, Iw. The three-phase-dq converter 50 then converts the three detected drive voltages Iu, Iv, Iw to two d- and q-axis detected electric currents Id, Iq.

The signals outputted from the resolver 24A are supplied continuously to the RD converter 24B. The RD converter 24B calculates the angle (rotational angle: θ) of the rotor in relation to the stator of the brushless motor 19, and supplies a motor angle signal θ to the dq-three-phase converter 45 and the three-phase-dq converter 50. Furthermore, the RD converter 24B calculates the rotational angular speed (W) on the basis of this angle (θ), and supplies a rotational angular speed signal W to the damper correction unit 34, the differentiation processor 35, and the decoupling controller 43, as previously described.

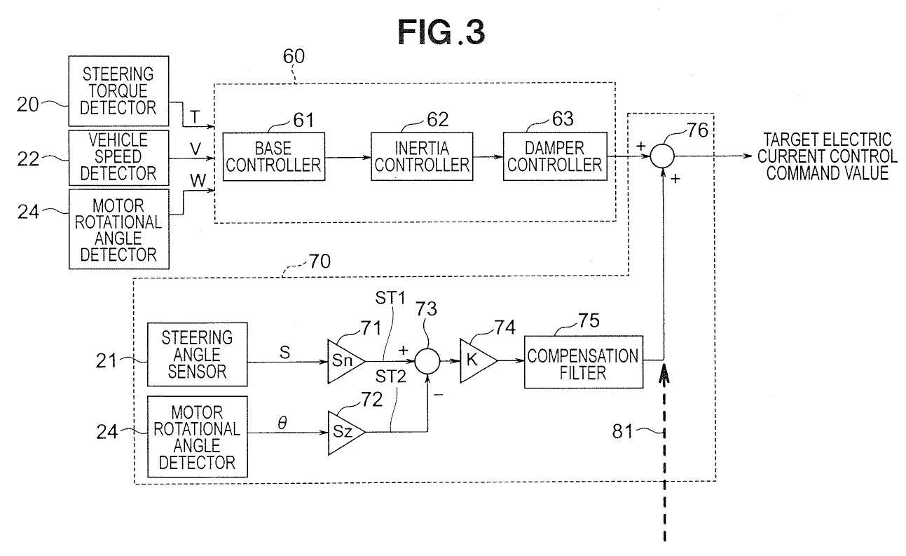

In the motor controller 30 described above, the block 60 shown by the dotted lines is a basic control component of the motor controller 30. A block diagram of the more mechanical aspects of the internal configuration of this basic control component 60 is shown in FIG. 3.

In FIG. 3, the basic control component 60 is configured from a base controller 61, an inertia controller 62, and a damper controller 63, all connected in cascade.

The base controller 61 is configured from the phase correction unit 31 and the target electric current setting unit 32 shown in FIG. 2.

The inertia controller 62 is configured from the inertia correction unit 33 and the addition computation unit 36 shown in FIG. 2.

The damper controller 63 is configured from the damper correction unit 34 and the subtraction computation unit 37 shown in FIG. 2.

The steering torque signal T from the steering torque detector 20, the vehicle speed signal V from the vehicle speed detector 22, and the rotational angular speed signal W from the motor rotational angle detector 24 are inputted to the basic control component 60. Furthermore, the d-axis final target electric current Id3 and the q-axis final target electric current Iq3, which are the damper-corrected target electric currents, are outputted from the damper controller 63, which is the last component of the series.

A rack load disturbance correction unit 70 is attached to the basic control component 60 of the electric power steering apparatus 10. This rack load disturbance correction unit 70 directly compensates for disturbances originating in loads on the rack shaft 14 (rack loads).

For the travel distance of the rack shaft 14 in the axial longitudinal direction (hereinafter referred to as “rack stroke”), the rack load disturbance correction unit 70 determines the deviation between a target rack stroke (ST1) set as a control target value and an actual rack stroke (ST2) measured in practice, and compensates for the aforementioned final target electric currents (d-axis final target electric current Id3 and q-axis final target electric current Iq3) in accordance with this deviation.

In the rack load disturbance correction unit 70, the target rack stroke ST1 is computed by a process in which a multiplication computation unit 71 multiplies a steering signal S (which corresponds to the steering angle or handle angle) by a steering gear ratio (Sn) outputted from the steering angle sensor 21. The actual rack stroke ST2 is computed by a process in which a multiplication computation unit 72 multiplies the motor angle signal θ outputted from the motor rotational angle detector 24 by a gear ratio (Sz) for converting the motor rotational angle to a rack stroke.

The computed target rack stroke ST1 and actual rack stroke ST2 are inputted to a deviation computation unit 73. The deviation computation unit 73 computes the deviation between the target rack stroke ST1 and the actual rack stroke ST2.

The deviation signal outputted from the deviation computation unit 73 is inputted to an addition computation unit 76 via an amplifier (K) 74 and a compensation filter 75. The addition computation unit 76 is disposed between the subtraction computation unit 37 and the deviation computation unit 41 in the configuration of the motor controller 30 shown in FIG. 2.

The addition computation unit 76 adds the deviation signal from the compensation filter 75 to the final target electric currents (d-axis final target electric current Id3 and q-axis final target electric current Iq3) outputted from the damper controller 63. A signal obtained by adding the deviation signal from the compensation filter 75 to the signal relating to the final target electric currents outputted from the damper controller 63 is supplied as a target electric current control command value to the deviation computation unit 41 (FIG. 2).

A sensor may also be added to measure the actual rack stroke ST2 directly.

The phrase “a deviation signal is outputted by the deviation computation unit 73” refers to a situation in which the originally expected rack stroke (target rack stroke ST1) did not occur due to a rack load component (disturbance).

Thus, since the electric power steering apparatus 10 has the rack load disturbance correction unit 70, control is performed so that the deviation signal, which is an output signal of the deviation computation unit 73, is brought to zero. It is thereby possible to directly compensate for disturbances originating in the load on the rack shaft 14.

In the configuration in which the rack load disturbance correction unit 70 is added to the basic control component 60, it is also possible to provide the rack load disturbance correction unit 70 by combining the unit with a structure 81 for providing feedback control of vehicle behavior, such as active reaction force, as shown by the dashed line.

The configurations and arrangement relationships described in the foregoing embodiment are merely schematic depictions intended to allow the present invention to be understood and implemented. Therefore, the present invention is not limited to the described embodiment, and can be modified to include various other forms that do not deviate from the technological scope depicted in the claims.

As described above, the present invention eliminates disturbances originating in rack loads by means of electric power steering that reduces the steering force of a driver in a passenger automobile or the like. The present invention is effective in providing an improved steering feel.

Obviously, various minor changes and modifications of the present invention are possible in light of the above teaching. It is therefore to be understood that within the scope of the appended claims the invention may be practiced otherwise than as specifically described.

What is claimed is:

1. An electric power steering apparatus for generating an auxiliary torque in accordance with a steering torque; the apparatus comprising:
first rack travel distance computation means for computing a target rack travel distance in accordance with a steering angle of a steering wheel;
second rack travel distance computation means for computing an actual rack travel distance;
deviation computation means for computing a deviation between the target rack travel distance and the actual rack travel distance; and
auxiliary torque correction means for correcting a value of the auxiliary torque so that a deviation signal outputted from the deviation computation means is zero.

2. The apparatus of claim 1, wherein the auxiliary torque correction means adds the deviation signal outputted from the deviation signal computation means to a target electric current control command value for generating the auxiliary torque.

3. The apparatus of claim 1, wherein the actual rack travel distance is determined based on a signal obtained by detecting a rotational angle of a motor for generating the auxiliary torque.

4. The apparatus of claim 3, wherein the rotational angle of the motor is detected by a resolver.
